(19) United States
(12) Patent Application Publication
(10) Pub. No.: US 2018/0182043 A1
(43) Pub. Date: Jun. 28, 2018

(54) JET ENGINE ASSET VALUE ANALYZER

(71) Applicant: General Electric Company, Schenectady, NY (US)

(72) Inventors: Ahilan RENGANATHAN, San Ramon, CA (US); Albert Chung-Chee KWOK, San Ramon, CA (US); Prashanth AYYAVU, San Ramon, CA (US); Timothy BRECHER, Grand Prairie, TX (US); Peter SINGH, San Ramon, CA (US); Thomas DEKKER, San Ramon, CA (US); Shahid MASUD, San Ramon, CA (US)

(21) Appl. No.: 15/389,892

(22) Filed: Dec. 23, 2016

(51) Int. Cl. G06Q 40/00

(52) U.S. Cl. CPC G06Q 40/12

(57) ABSTRACT

A system, method, and computer-readable medium to receive, via a user interface, a request to create a valuation for a jet engine asset; retrieve information relevant to the jet engine asset for which the valuation is to be created, the information including at least historical data related to a status of the jet engine asset and current market trends; analyze the retrieved information using heuristics to determine a value of the jet engine asset for at least one asset disposition scenario; store a report of the determined value of the jet engine asset; and display, via the user interface, the report of the determined value of the jet engine asset.

### BACKGROUND

Jet Engines are one of the most valuable assets in the aviation industry. Jet engine valuation is a process of analyzing and evaluating used jet engine and jet engine parts in terms of, for example, life remaining, required repair and other costs, and potential profit that can be made out of it. All of the data related to a jet engine valuation process for even a single jet engine can be quite large. As such, the processing and analysis of such data might be a tremendous processing tasks. Additionally, even after such data is processed the reporting and analysis of the data can be a challenge.

### SUMMARY

In an aspect of an example embodiment, provided is a method to receive, via a user interface, a request to create a valuation for a jet engine asset; retrieve information relevant to the jet engine asset for which the valuation is to be created, the information including at least historical data related to a status of the jet engine asset and current market trends; analyze the retrieved information using heuristics to determine a value of the jet engine asset for at least one asset disposition scenario; store a report of the determined value of the jet engine asset; and display, via the user interface, the report of the determined value of the jet engine asset.

In some other embodiments, a system and a computer-readable medium is provided to, for example, implement aspects of the methods disclosed herein.

### BRIEF DESCRIPTION OF THE DRAWINGS

FIG. 1 is an example block diagram of a system architecture;

FIG. 2 is an example flow diagram of some aspects of a process to valuate jet engine assets herein;

FIG. 3 is an outward view of an example of a user interface for a part out valuation scenario;

FIG. 4 is an outward view of an example of a user interface for a lease valuation scenario;

FIG. 5 is an outward view of an example user interface, according to some embodiments;

FIG. 6 is an outward view of an example user interface, according to some embodiments;

FIG. 7 is an outward view of an example user interface, according to some embodiments; and

FIG. 8 is an illustrative depiction of a computing system to determine a jet engine value, according to some embodiments.

### DETAILED DESCRIPTION

The following description is provided to enable any person in the art to make and use the described embodiments. Various modifications, however, will remain readily apparent to those in the art.

In some example contexts, use-cases, and embodiments, one or more terms will be used in the present disclosure. As a matter of introduction and to ease the understanding of the present disclosure, a number of terms will be introduced, where the full meaning of the following terms will be further understood in context of the disclosure herein, on the whole.

Data related to a jet engine (e.g., covering the life cycle of the jet engine) can be recorded or transmitted to a cloud-based or other remote computing environment. By bringing such asset data into a cloud-based computing environment, new software applications informed by industrial processes, tools and know-how can be constructed, and new physics-based analytics specific to an industrial environment can be created. Insights gained through analysis of such jet engine data can lead to enhanced analysis, enhanced software algorithms for managing the same or similar assets, better operating efficiency, and the like. In addition to the examples provided herein, the valuations regarding two separate jet engines may be analyzed together/compared to develop insights into segment(s) of jet engine assets.

Data related to jet engine assets may be collected and transmitted to or retrieved by a central asset valuation analysis application included within a cloud computing platform for automated processing, analysis by trained personnel, and dissemination to operational managers for action.

The systems and methods herein for generating and reporting valuations of jet engine assets described herein can include or can be a portion of an Industrial Internet of Things (IIoT) such as the Predix™ platform available from General Electric (GE). In an example, an IIoT connects equipment and machine assets from industrial fields and healthcare fields, such as turbines, jet engines, healthcare machines, and locomotives, to the Internet or cloud, or to each other in some meaningful way such as through one or more networks. The systems and methods described herein can include using a “cloud” or remote or distributed computing resource or service. The cloud can be used to receive, relay, transmit, store, analyze, or otherwise process information for or about one or more assets such as aircraft.

According to various embodiments, a cloud computing system may receive or retrieve data regarding jet engine assets for jet engines (e.g., hundreds or thousands of engines), including historical operational, maintenance, and sales data dating back many years (e.g., decades) that belong to the same business organization. In an example, the cloud computing system may include at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

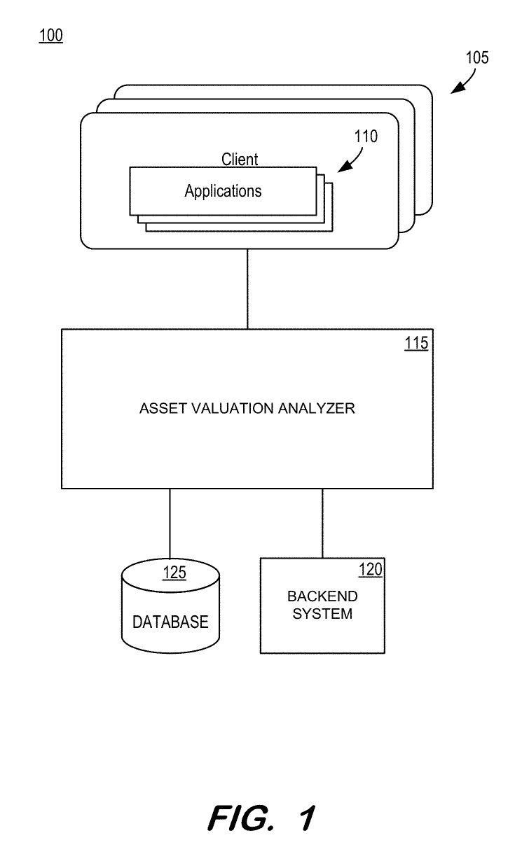

FIG. 1 illustrates a cloud-based system 100 for generating and managing valuations for jet engine assets, in accordance with an example embodiment. Examples of some embodiments of the present disclosure are not limited to the particular architecture 100 shown in FIG. 1.

The cloud computing system 115 may be one or more of a server, computer, database, and the like, included in a cloud-based platform. In this case, the cloud computing system 115 may receive data related to jet engine assets for all of the jet engines owned and/or managed by a particular business organization across many different jet engines (e.g., thousands of different jet engines over a period of decades).

The jet engine asset data may be provided to the cloud computing system 115 directly, or they may be provided via one or more intermediate devices. The jet engine asset data may be provided to the cloud computing system 115 via a network such as a private network, a public network (e.g., the Internet), or some combination thereof. In some examples, a user client device 105 is also connected to the cloud computing system 115 via a network. As another example, the client device 105 may be directly connected to the cloud computing system 115, or the function of the user device may be performed by a user locally on the cloud computing system 115.

System 100 includes one or more client devices 105 running one or more applications 110. Applications 110 may, in some embodiments, include a suite of different software applications having, at least to some extent, related functionality, similar user interfaces, and some ability to exchange data with each other. Applications 110 may include different software applications that support the operations and process of an organization. In some embodiments, one of the applications 110 may include functionality or a tool to analyze and evaluate used jet engine assets in terms of, for example, life remaining in the jet engine asset, repair costs, and a potential profit resulting from disposing of the jet engine asset. In some embodiments, applications 110 may be configured to facilitate, support, and execute a program to create, modify, and interact with one or more valuations for jet engine assets (also referred to herein as charts and simply, jet engines). The visualizations created and processed herein may be implemented by an application.

System 100 includes an asset valuation analyzer service or server 115. In some embodiments, a functionality or service for creating, analyzing, manipulating, and rendering jet engine valuations as a cloud-based service, whereas in some other embodiments system 100 may include a client-server architecture. System 100 may encompass both scenarios. In the instance system 100 includes a server at 115, the devices at 105 may be client devices running applications as discussed above. In an instance system includes a cloud-based server at 115, the devices at 105 may execute a browser that is used by a user to interface with service 115.

System 100 further includes a backend system that can, automatically in some instances, in response to a request or call from an asset valuation analyzer (AVA) service 115, execute tasks, code, or instructions to perform a process to create and/or support the creation and rendering of visualizations managed, at least in part, thereby. In some aspects herein, a user may provide an indication or request the creation and/or analysis of one or more valuations for a jet engine, as implemented in an application 110 and/or server or service 115, which may operate in cooperation with the processing of a backend system 120 to generate a program or response to effectuate the creation and analysis of jet engines that may be used to provide insight to an organization.

In one example, a client 105 executes an application 110 to create and/or analyze one or more jet engine assets via a user interface (UI) presented to a user on a display of client 105. The user manipulates UI elements within the UI to indicate and specify at least one value for one or more parameters and variables that define a valuation for the jet engine asset, where a server or service 115 embodying the asset valuation analyzer operates, in cooperation with backend system 120 and database 125 to generate, for example, a valuation report including a determined (i.e., calculated) value of the jet engine asset for a specific jet engine efficiently, accurately, and quickly.

Data store 125 may comprise any data source or sources that are now known or become known. Data store 125 may comprise a relational database, a HTML document, an eXtensible Markup Language (XML) document, or any other data storage system storing structured and/or unstructured data files. The data of data store 130 may be distributed among several data sources. Embodiments are not limited to any number or types of data sources.

Data store 125 may implement an “in-memory” database, where a full database is stored in volatile (e.g., non-disk-based) memory (e.g., Random Access Memory). The full database may be persisted in and/or backed up to fixed disks (not shown). Embodiments herein are not limited to an in-memory implementation. For example, data may be stored in Random Access Memory (e.g., cache memory for storing recently-used data) and other forms of solid state memory and/or one or more fixed disks (e.g., persistent memory for storing their respective portions of the full database).

Although not shown in FIG. 1, the system 100 may also be connected to an asset community (e.g., turbines, healthcare, power, industrial, manufacturing, etc.) that is communicatively coupled with the cloud computing system 115.

The cloud computing system 115 may include several layers, for example, a data infrastructure layer, a cloud foundry layer, and modules for providing various functions. As a non-limiting example, the cloud computing system 115 may include an asset module, an analytics module, a data acquisition module, a data security module, an operations module, and the like. Each of the modules may include or may use a dedicated circuit, or instructions for operating a general purpose processor circuit, to perform the respective functions. The modules may be communicatively coupled within the cloud computing system 115 such that information from one module can be shared with another. As one example, the modules may be co-located at a designated datacenter or other facility, or the modules can be distributed across multiple different locations.

Client 105 (e.g., computer, mobile device, workstation, tablet, laptop, appliance, kiosk, and the like) may be configured for data communication with the cloud computing system 115.

Although not shown in FIG. 1, system 100 may include other devices and systems such as a device gateway. The device gateway can couple the cloud computing system 115 to one or more other assets or asset communities, an enterprise computing system, and/or other devices. System 100 thus represents a scalable industrial solution that extends from a physical or virtual asset to a remote cloud computing system 115. Cloud computing system 115 optionally includes a local, system, enterprise, or global computing infrastructure that can be optimized for industrial data workloads, secure data communication, and compliance with regulatory requirements.

In accordance with some aspects of the present disclosure, an asset valuation analyzer service or application herein provides a mechanism and environment that supports the creation and rendering of jet engine asset valuations based on large sets of data including all of the key factors and variables that might impact the determination of the valuation. The key factors and variables might include historical data regarding specific aspects of a particular jet engine such as, for example, the operational status and usage, repair history, outstanding upgrades, market trends related to the particular jet engine.

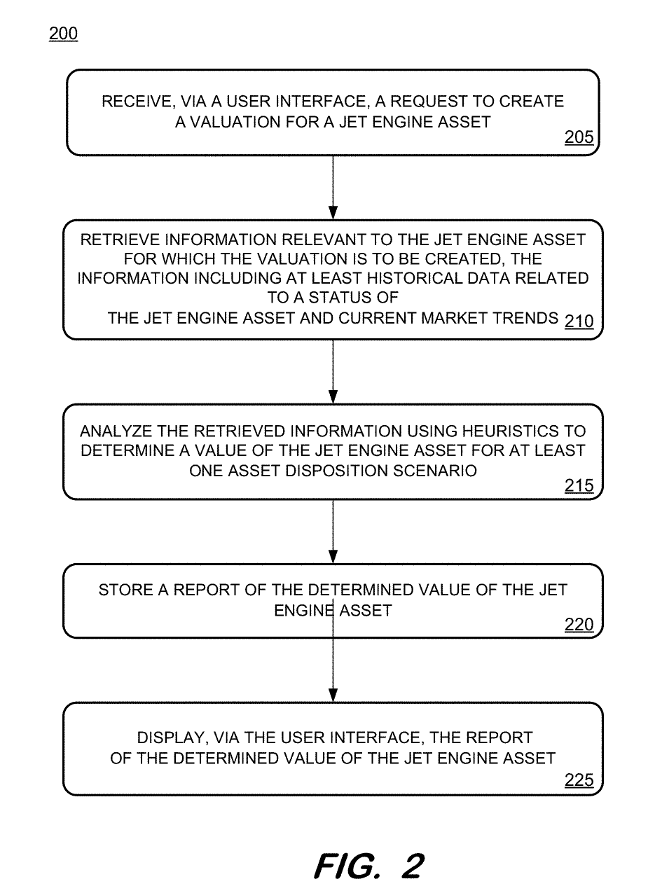

FIG. 2 is an example flow diagram of a process 200, in accordance with some embodiments herein. Process 200 may begin at an initial operation 205. At operation 205, a request to create a valuation for a jet engine asset is received via a user interface. The user interface may be displayed on a client device (e.g., FIG. 1, 105) executing an application (e.g., FIG. 1, 110). In some embodiments, the user interface might include a browser interface. The request may be invoked in reply to a user's direct or indirect interaction with UI elements included in the user interface. The request is not explicitly shown in FIG. 1 but is understood to occur, by some method.

At operation 210, information relevant to the particular jet engine asset of the request received at operation 205 for which the valuation of the present example is to be created is retrieved. The information may be housed in a data store of a database or, in some instances, a data mart thereof. The information retrieved at operation 210 may include historical data of at least one of a status of the engine and market trends data. The historical data may include data points up until and including a current state of the jet engine and a current market trends. Additional information, including all existing information about the jet engine asset may also be retrieved, including for example, usage data, past engine valuations, and historical sales data for the particular engine be evaluated and related (i.e., similar) jet engines. In some aspects, the particular jet engine asset under consideration can be positively and uniquely identified by its engine serial number (ESN). The relevant data may be owned by a single entity. For an ESN in an accessible database (e.g., database 125 of FIG. 1), other relevant information associated with the ESN and the corresponding jet engine can be automatically retrieved based on a user supplying an ESN to the system. In some embodiments, the ESN may be entered into the system by a user via an outwardly facing user interface displayed on a client device of the user.

Continuing to operation 215, the retrieved information is analyzed in an effort to determine a value of the jet engine asset. The analysis, in some embodiments, might include heuristic analysis of all of the relevant (e.g., historic operational and state data, usage data, maintenance records, past valuations, sales data, market environment data, etc.) in order to get accurate results in a fast and efficient manner. The valuation determined at operation 215 can be provided for one of more specific disposition scenarios. For example, a valuation may be determined for the jet engine asset for at least one of (1) an engine part out scenario where the different components of the jet engine will be offered for sale individually, (2) an engine lease scenario where the jet engine asset will be offered for lease, and (3) an engine exchange scenario where the jet engine asset will be exchanged for another jet engine. Operation 215 may determine a valuation for one of or all three of the disposition scenarios above. In some embodiments, one or more other, different, alternative or substitute disposition scenarios may be considered in a valuation determination analysis and calculation herein. The different disposition scenarios may dictate that the different factors analyzed in the valuation process be different and/or weighed differently to account for each disposition scenario.

In some aspects, the valuation determined at operation 215 is recorded in a report and stored in a memory, as depicted in operation 220. The valuation may be persisted in a memory for a future use and consideration by a user or other entity (i.e., a different application). In some aspects, the valuation may be expressed in terms of at least one of life remaining for the jet engine, required repair costs, required compliance costs to upgrade the jet engine so that it is compliant with current and/or anticipate compliance standards, and a potential profit that would (likely) result from a disposition of the jet engine.

Process 200 continues to operation 225 where the report of the valuation of the jet engine asset is displayed to a user or other entity. The report may be presented via a user interface of a user computing device and the report itself may be configured as a graphical presentation including one or different types of charts and other UI visualization representations (e.g., a combination of graphics, numerals, and text).

In some embodiments, a valuation for a single jet engine might be displayed in a visualization via a user interface. In some embodiments, a visualization might include two or more valuations, where the multiple visualizations relate to the same or different jet engine assets. Process 200 may include more, fewer, or alternative operations, and in some embodiments may comprise a portion of another process.

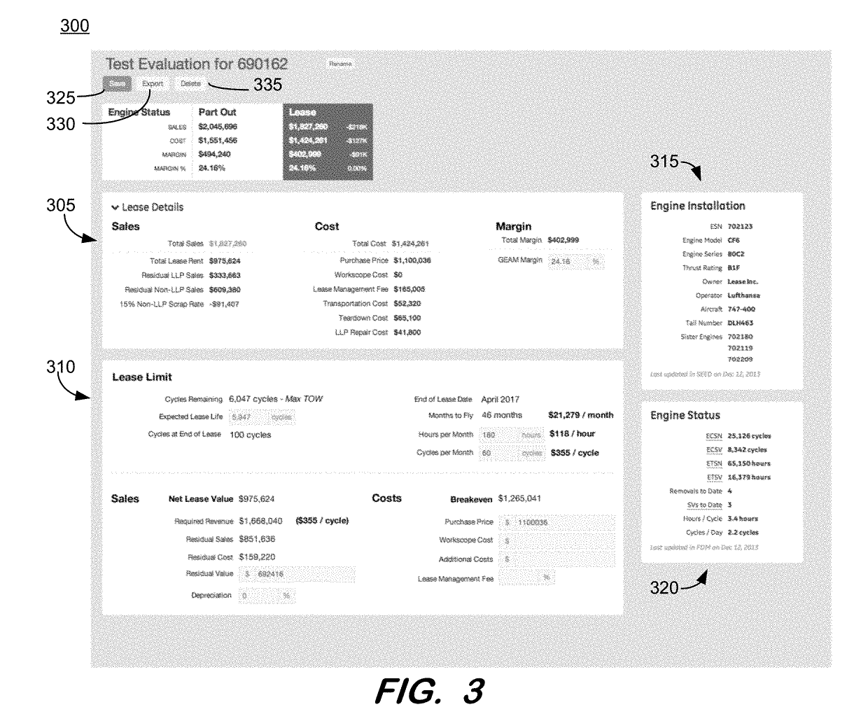

FIG. 3 is an illustrative depiction of a report of a valuation for a particular jet engine asset, as determined for a lease scenario. Report 300 includes values calculated and determined based on an analysis by a AVA system (e.g., FIG. 1, system 100) of all of the information relevant to a particular, specific jet engine (e.g., ESN 702123). Report or visualization 300 includes lease details at 305, including sales, cost, and profit margin data. Additional details related to the lease and sales figures are shown at 310. The specifics of the engine's installation are grouped in display pane 315 and the current status of the engine at a particular point in time is presented in display pane 320. The report shown in FIG. 3 may be saved, exported, or deleted by the selection of UI elements 325, 330, and 335, respectively.

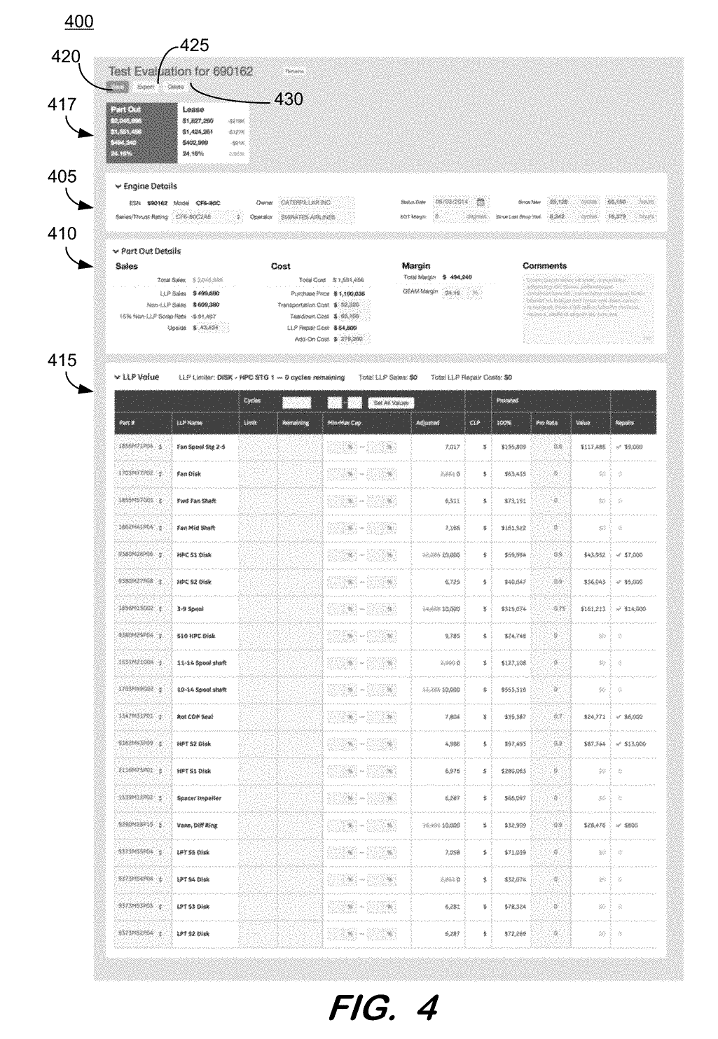

FIG. 4 is an illustrative depiction of a report of a valuation for a particular jet engine asset, as determined for a part out scenario. Report 400 includes values calculated and determined based on an analysis by an AVA system analyzing of all of the information relevant to a particular, specific jet engine. Visualization 400 includes engine details at 405 and part out details including sales, cost, and profit margin data at 410. Limited life part (LLP) details for the engine are grouped in display pane 415, for different parts of the engine. A comparative summary listing of a “part out” scenario and a “lease” scenario for the subject jet engine asset is presented at 417. The report shown in FIG. 4 may be saved, exported, or deleted by the selection of UI elements 420, 425, and 430, respectively.

In some embodiments, an application, plug-in, application programming interface (API), or other components may be used, alone or in combination, to implement a tool in a context or domain such as, for example, a jet engine asset valuation process. In particular, the tool may enhance aspects of a form-based data input/output process. Regarding some embodiments of a jet engine asset valuation process and system, the tool may comprise intelligent fields, a rules engine, and a smart windows user interface component.

In the context of a jet engine valuation, a user might interact with the intelligent fields during a process of creating a valuation for the jet engine. The intelligent fields may be configured as different types of UI elements, including but not limited to a text field, a text area, a drop down menu, a UI button, a UI radio button, a checkbox, and other UI element representations that can receive interactions and inputs from a user.

A rules engine of the tool may include a browser-based rules engine. The rules engine may specify how data values entered into one or more of the intelligent fields affects or is related to a valuation, including the different aspects thereof (e.g., profitability, costs, etc.). In some instances, the rules engine may (at least logically) create a dependency graph that connects different intelligent fields that are interrelated to each other. In this manner, an entry to one intelligent field may trigger a reactive change in a different but related intelligent field so that all of the connected and impacted intelligent fields are updated as entries/changes are made to one intelligent field.

In some aspects, making a change in an intelligent filed might not trigger or result in a call or execution of an analytics determination based on historical (and other) data. Instead, valuation results are accessible by the in-browser rules engine (e.g., stored in a browser's memory as key-value pairs) and are changed based on the user's value entry in the intelligent fields.

The “smart window” aspect of the tool may include a UI component comprising a display pane that may overlay a portion of a valuation visualization. In some embodiments, the smart window may be sized to occupy less than a full extent of a display of valuation report. In some embodiments, the smart window may be moveable and can optionally be resized.

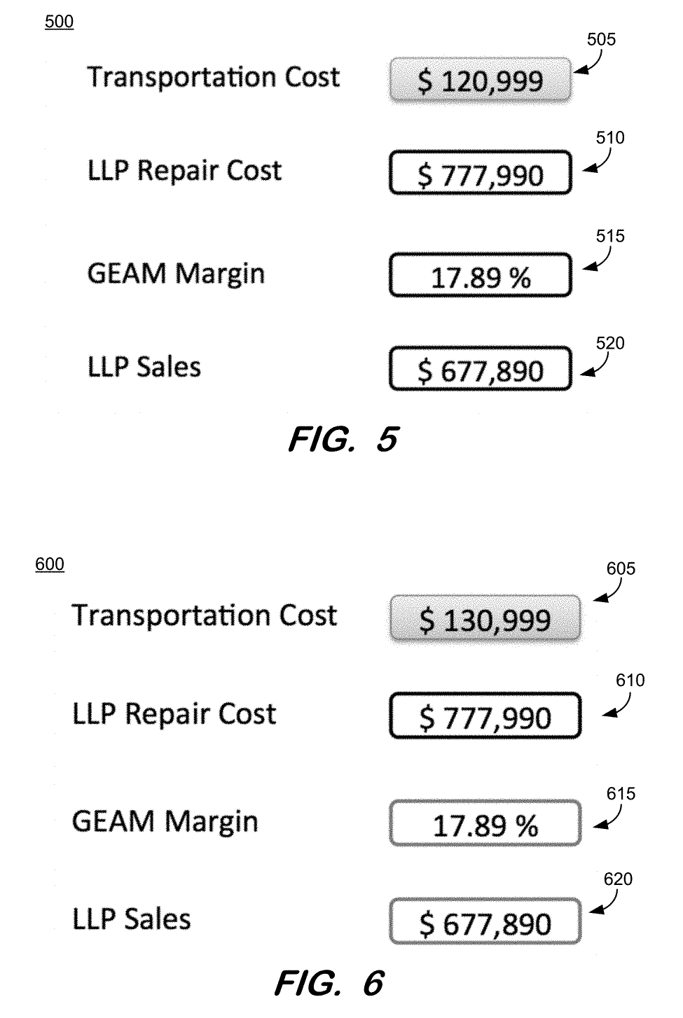

FIG. 5 is an illustrative depiction of an outward view of a UI display 500. UI 500 includes a number of input fields, in the form of UI input boxes 505, 510, 515, and 520, where each input filed relates to a different parameter. FIG. 5 illustrates an example of a user selecting a value (i.e., “$120,999”) in an intelligent field 505. In the example of FIG. 5, intelligent field 505 is highlighted in response to a user's selection thereof.

FIG. 6 is an illustrative depiction of an outward view of a UI 600. In FIG. 6, intelligent fields related to intelligent filed 605 having the value thereof changed (i.e., 130,999) are also highlighted by having the border of the UI elements 615 and 620 displayed in an alternative color (e.g., red instead of the usual black). The highlighting may include a code regarding an aspect of the valuation, such as a profit projection. For example, red highlighting may indicate a negative impact on the profit, yellow may indicate a neutral impact, and green may indicate a positive impact on the profitability. In the example of FIGS. 5 and 6, changing the value of the transportation cost from $120,999 to $130,999 impacts the “GEAM Margin” and the “LLP Sales”, which has a negative impact on the profitability of the current valuation, as indicated by the red border of intelligent fields 615 and 620.

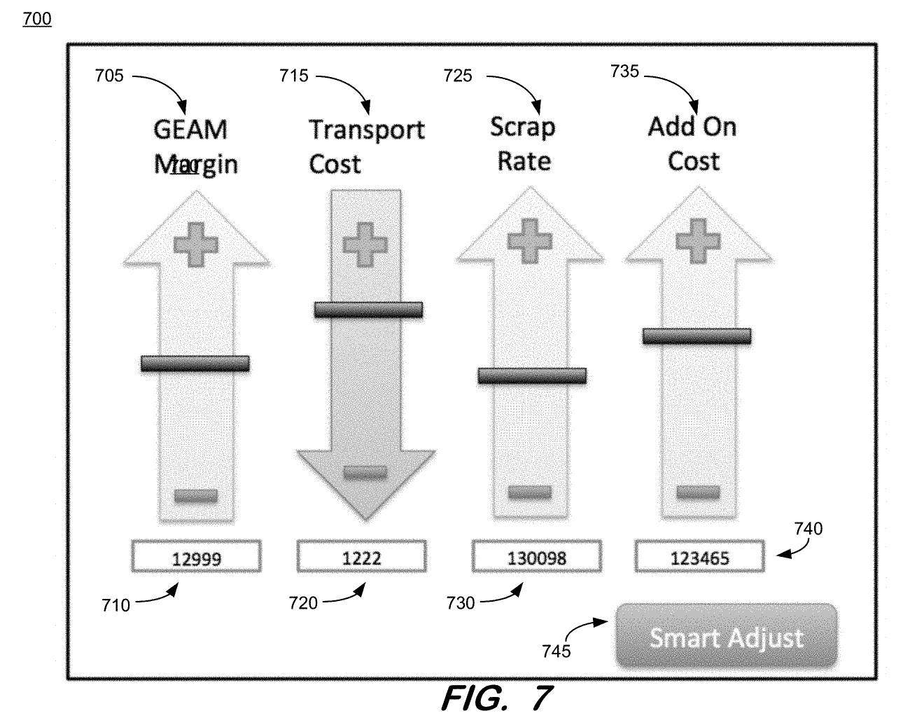

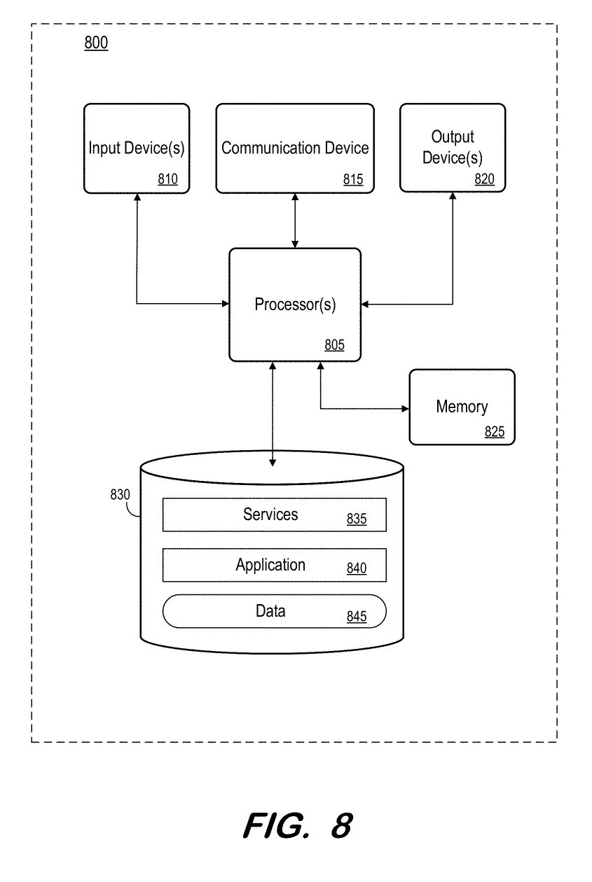

FIG. 7 is an illustrative depiction of an outward view of a UI 700. In FIG. 7, UI 700 includes a visualization of a set of adjustable (by a user) user interface elements that can be adjusted by a user to change interrelated aspects of a valuation. In the example of FIG. 7 “smart window” may be presented in response to a user entering a value into an intelligent field. UI 700 includes a further suggestion of how a user might increase a profitability (or other factor) by changing certain interrelated values. FIG. 7 includes a plurality of interrelated values 705, 715, 725, and 735 and their associated value, 710, 720, 730, and 740, respectively, as suggested by an input tool herein. Each UI representation of a slider bar for changing its associated value is color coded, in a similar manner as discussed above. A user can may additional changes to the suggestion values presented in UI 700 by selecting and moving one or more of the slide bars. A user may accept the values presented in FIG. 7 by selecting the “Smart Adjust” UI button 745.

Apparatus 800 includes processor 805 operatively coupled to communication device 820, data storage device 830, one or more input devices 810, one or more output devices 820 and memory 825. Communication device 815 may facilitate communication with external devices, such as a reporting client, or a data storage device. Input device(s) 810 may comprise, for example, a keyboard, a keypad, a mouse or other pointing device, a microphone, knob or a switch, an infra-red (IR) port, a docking station, and/or a touch screen. Input device(s) 810 may be used, for example, to enter information into apparatus 800. Output device(s) 820 may comprise, for example, a display (e.g., a display screen), a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 825 may comprise Random Access Memory (RAM), Storage Class Memory (SCM) or any other fast-access memory.

Services 835 and application 840 may comprise program code executed by processor 805 to cause apparatus 800 to perform any one or more of the processes described herein (e.g., FIG. 2). Embodiments are not limited to execution of these processes by a single apparatus.

Data 845 (either cached or a full database) may be stored in volatile memory such as memory 825. Data storage device 830 may also store data and other program code and instructions for providing additional functionality and/or which are necessary for operation of apparatus 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A method to evaluate jet engine assets, the method comprising:
receiving, via a user interface, a request to create a valuation for a jet engine asset;
retrieving information relevant to the jet engine asset for which the valuation is to be created, the information including at least historical data related to a status of the jet engine asset and current market trends;
analyzing the retrieved information using heuristics to determine a value of the jet engine asset for at least one asset disposition scenario;
storing a report of the determined value of the jet engine asset; and
displaying, via the user interface, the report of the determined value of the jet engine asset.

2. The method of claim 1, wherein the jet engine asset is one of a specific jet engine and components of a specific jet engine.

3. The method of claim 1, wherein the information relevant to the jet engine asset for which the valuation is to be created further comprises at least one of past engine valuations and historical sales data.

4. The method of claim 1, wherein the determined value for the jet engine asset is expressed in terms of at least one of life remaining, required repair costs, compliance update costs, and potential profit resulting from a disposition of the jet engine asset.

5. The method of claim 1, wherein the at least one asset disposition scenario includes an engine part out scenario, an engine lease scenario, and an engine exchange scenario.

6. The method of claim 1, wherein the user interface comprises:
a user interface element to receive a value from a user; and
a rules engine that specifies how the value received from the user impacts the determined value of the jet engine asset.

7. The method of claim 6, wherein the user interface includes a display of a set of adjustable user interface elements that can be adjusted by a user to change interrelated aspects of the determined jet asset valuation.

8. A system comprising:
a memory storing processor-executable instructions; and
a processor to execute the processor-executable instructions to cause the system to:
receive, via a user interface, a request to create a valuation for a jet engine asset;
retrieve information relevant to the jet engine asset for which the valuation is to be created, the information including at least historical data related to a status of the jet engine asset and current market trends;
analyze the retrieved information using heuristics to determine a value of the jet engine asset for at least one asset disposition scenario;
store a report of the determined value of the jet engine asset; and
display, via the user interface, the report of the determined value of the jet engine asset.

9. The system of claim 8, wherein the jet engine asset is one of a specific jet engine and components of a specific jet engine.

10. The system of claim 8, wherein the information relevant to the jet engine asset for which the valuation is to be created further comprises at least one of past engine valuations and historical sales data.

11. The system of claim 8, wherein the determined value for the jet engine asset is expressed in terms of at least one of life remaining, required repair costs, compliance update costs, and potential profit resulting from a disposition of the jet engine asset.

12. The system of claim 8, wherein the at least one asset disposition scenario includes an engine part out scenario, an engine lease scenario, and an engine exchange scenario.

13. The system of claim 8, wherein the user interface comprises:
a user interface element to receive a value from a user; and
a rules engine that specifies how the value received from the user impacts the determined value of the jet engine asset.

14. The system of claim 13, wherein the user interface includes a display of a set of adjustable user interface elements that can be adjusted by a user to change interrelated aspects of the determined jet asset valuation.

15. A computer-readable medium having processor executable instructions stored thereon, the medium comprising:
instructions to receive, via a user interface, a request to create a valuation for a jet engine asset;
instructions to retrieve information relevant to the jet engine asset for which the valuation is to be created, the information including at least historical data related to a status of the jet engine asset and current market trends;
instructions to analyze the retrieved information using heuristics to determine a value of the jet engine asset for at least one asset disposition scenario;
instructions to store a report of the determined value of the jet engine asset; and
instructions to display, via the user interface, the report of the determined value of the jet engine asset.

16. The medium of claim 15, wherein the jet engine asset is one of a specific jet engine and components of a specific jet engine.

17. The medium of claim 15, wherein the information relevant to the jet engine asset for which the valuation is to be created further comprises at least one of past engine valuations and historical sales data.

18. The medium of claim 15, wherein the determined value for the jet engine asset is expressed in terms of at least one of life remaining, required repair costs, compliance update costs, and potential profit resulting from a disposition of the jet engine asset.

19. The medium of claim 15, wherein the at least one asset disposition scenario includes an engine part out scenario, an engine lease scenario, and an engine exchange scenario.

20. The medium of claim 15, wherein the user interface comprises:
a user interface element to receive a value from a user; and
a rules engine that specifies how the value received from the user impacts the determined value of the jet engine asset.
